(19) United States
(12) Patent Application Publication
(10) Pub. No.: US 2014/0114879 A1
(43) Pub. Date: Apr. 24, 2014

(54) SYSTEMS AND METHODS FOR PROVIDING INVESTING OPPORTUNITIES

(71) Applicants: SANTOSH JOHN THOMAS, Gaborone (BW); SATISH JOSEPH THOMAS, Sammamish, WA (US)

(72) Inventors: SANTOSH JOHN THOMAS, Gaborone (BW); SATISH JOSEPH THOMAS, Sammamish, WA (US)

(21) Appl. No.: 13/658,710

(22) Filed: Oct. 23, 2012

(51) Int. Cl. G06Q 40/06

(52) U.S. Cl. 705/36 R

(57) ABSTRACT

The present invention is directed toward systems and methods for providing investment opportunities to a communication device carried by a user. The method is implemented by a computer-implemented system in communication with the communication device via a communication network. The systems and methods include collecting location information and/or receiving graphical images from the user, identifying investment options corresponding to the collected location information or the received graphical images, providing the identified investment options to the communication device carried by the user, and enabling the user to invest in the identified investment options for their investment related needs by providing an investment platform capable of being used by the user for transacting in stocks related to the investment options.

### FIELD OF THE INVENTION

The present invention generally relates to systems and methods for providing investing opportunities to a communication device carried by a user, and more particularly, to systems and methods for providing investing opportunities based upon at least one of a location of the user or a graphical image provided by the user.

### BACKGROUND OF THE INVENTION

In today's marketplace, new investing opportunities are being opened everyday. The growth of the internet has enabled an investor to search and retrieve business information online. Oftentimes, the investor is not even aware that a particular company or a related sector in a given area exists. Therefore, having timely business information is valuable for the investor.

Many conventional systems exist over the internet for timely providing business information to the investor. However, such conventional systems suffer from many drawbacks. One of the most important drawbacks of such systems is that the business information is provided as per the geographic area, thus requiring the investor to filter through numerous businesses that are too far away from the location, where the investor is interested in investing. Furthermore, the existing online services do not provide the business information in an effective and efficient manner. Still further, when the investor is interested in knowing about companies or related sectors, or is interested in investing in companies or in related sectors, there is no way to quickly determine what options are available in the given area to meet the particular needs.

Accordingly, a need currently exists for providing and allowing the investor to obtain and use business information on the go. To provide the business information in an effective and efficient manner, attempts have been made to develop new systems and methods. Therefore, there is a need of having systems that are capable of continuously uncovering potential investment opportunities for the investor.

For example, Korean patent publication number 20110078647 describes a system and method that is capable of providing store information, and similar store information adjacent to a smart phone user, to a user. Such system and method is a good attempt of providing relevant business information to the investor, however, in such conventional system, the user is required to manually input or provide the location for which he requires the information. Similarly, in another example as disclosed in Korean patent publication number 2011021507, a method is described where company information is provided from a panoramic image provided by the user.

Although these new type of systems and methods provide business information, it has been found that they have several limitations. One of such limitation is that the business information provided is not of the kind which can be used as an investment opportunity. Secondly, none of these systems and methods relates to integrating an entire third party investment platform or an investment platform wherein the identified investment opportunities could be best utilized for the actual investment of money.

Therefore, there is a need for making systems and methods for providing investing opportunities to the investor. There is a need for providing investing and other related business information to the investor corresponding to a particular location in an effective and efficient manner. Furthermore, there is a need to allow the investor to use the identified investing and other related business information for his investment purposes. Moreover, there is a need for providing systems and using methods which makes available key investment information to the investor. Such systems may rectify the aforementioned disadvantages and drawbacks.

### SUMMARY OF THE INVENTION

In view of the foregoing disadvantages or drawbacks inherent in the prior art systems and methods, the general purpose of the present invention is to provide systems and methods for providing investing opportunities that is constructed to include all of the advantages of the prior art systems and methods, to overcome the drawbacks inherent in the prior art, and to offer some added advantages.

To achieve the above objectives and to fulfill the identified needs, in accordance with a first aspect, the present invention provides a method for providing investment opportunities to a communication device carried by a user. The method is implemented by means of a computer-implemented system in communication with the communication device via a communication network. The method includes collecting location information sent by the communication device. Furthermore, the method includes identifying investment options corresponding to the collected location information, and providing the identified investment options to the communication device carried by the user. The user may then invest in the identified investment options.

In accordance with a second aspect, the present invention provides a method for providing investment opportunities to a communication device carried by a user. The method is implemented by means of a computer-implemented system in communication with the communication device via a communication network. The method includes collecting location information sent by the communication device. Furthermore, the method includes identifying investment options corresponding to the collected location information. The method further includes providing the identified investment options to the communication device carried by the user. Still further, the method includes enabling the user to invest in the identified investment options for the investment related needs by providing an investment platform capable of being used by the user for transacting in stocks related to the investment options.

In accordance with a third aspect, the present invention provides a method for providing investing opportunities to a communication device carried by a user. The method is implemented by a computer-implemented system in communication with the communication device via a communication network. The method includes receiving a graphical image from the user wherein the graphical image is received via the communication device carried by the user. Furthermore, the method includes identifying investment options corresponding to the graphical image received from the user. The method further includes providing the identified investment options to the communication device carried by the user. The user is able to invest in the identified investment options in accordance with the investment related needs.

In accordance with a fourth aspect, the present invention provides a method for providing investing opportunities to a communication device carried by a user. The method is implemented by a computer-implemented system in communication with the communication device via a communication network. The method includes receiving a graphical image from the user, wherein the graphical image is received via the communication device carried by the user. Furthermore, the method includes identifying investment options corresponding to the received graphical image. The method further includes providing the identified investment options to the communication device carried by the user. Still further, the method includes enabling the user to invest in the identified investment options for the investment related needs by providing an investment platform capable of being used by the user for transacting in stocks related to the investment options.

In accordance with a fifth aspect, the present invention provides a system for providing investment opportunities to a communication device carried by a user. The system includes a location collecting module configured to collect location information from the communication device carried by the user. Furthermore, the system includes a processing module in communication with the location collecting module. The processing module is configured to identify a location of the user based on the collected location information and to retrieve an investment opportunity corresponding to the identified location, wherein the investment opportunity is retrieved from a database having investment opportunities corresponding to a plurality of locations pre-stored therein. Still further, the system includes an information delivery module configured to receive the investment opportunity from the processing module and to provide the investment related information to the communication device carried by the user.

In accordance with another aspect, the present invention provides a system for providing investment opportunities to a communication device carried by a user. The system includes a graphical image receiving module configured to receive a graphical image from the communication device carried by the user. Furthermore, the system includes a processing module in communication with the graphical image receiving module. The processing module is configured to identify the graphical image received from the user and retrieve an investment option corresponding to the identified graphical image, wherein the investment option is retrieved from a database having investment options corresponding to a plurality of graphical images pre-stored therein. Still further, the system includes an information delivery module coupled to the processing module. The information delivery module is configured to receive the investment option from the processing module and provide the investment option to the communication device carried by the user.

In accordance with yet another aspect, the present invention provides a computer program product for use with a computer. The computer program product includes a computer usable medium having a computer readable program code stored thereon for providing investment opportunities to a communication device carried by a user. The computer program product performs the steps of collecting location information from the communication device carried by the user, identifying investment related information corresponding to the collected location information, and providing the identified investment related information to the communication device carried by the user. The user uses the identified investment related information for the investment related needs.

The foregoing, together with other aspects of the present invention, along with the various features characteristic of the present invention, will be pointed out and noted with particularity in the claims that are annexed hereto, and forms a part of the present invention. For a better understanding of the present invention, its operating advantages, and the specific objects attained by its uses, reference should be made to the accompanying descriptive matter and drawings in which there are illustrated exemplary embodiments of the present invention.

### BRIEF DESCRIPTION OF THE DRAWINGS

The advantages and features of the present disclosure will become better understood with reference to the following detailed description and claims taken in conjunction with the accompanying drawings, in which:

FIG. 1 is a block diagram of a system for providing investment opportunities corresponding to a location, according to a first embodiment of the present invention;

FIG. 2 is a block diagram of a system for providing investment opportunities corresponding to an image provided by a user, according to a second embodiment of the present invention;

FIG. 3 is a flow diagram of a method for identifying and providing investment options corresponding to a location information, according to an embodiment of the present invention;

FIG. 4 is a flow diagram of a method for collecting location information, according to an embodiment of the present invention;

FIGS. 5-6 are flow diagrams of a method for identifying a list of companies, in which various embodiments of the present invention may be practiced;

FIGS. 7-8 are flow diagrams of a method for identifying and providing investment options corresponding to a graphical image provided by a user, in which various embodiments of the present invention may be practiced;

FIGS. 9-11 illustrate schematic diagrams about how the system functions, in which various embodiments of the present invention may be practiced; and

FIG. 12 is a sample look-up table stored in a database, according to an embodiment of the present disclosure.

Like numerals refer to like elements throughout the present disclosure.

### DETAILED DESCRIPTION OF THE ILLUSTRATED EMBODIMENTS

The exemplary embodiments described herein disclose details for illustrative purposes only and are subject to many variations in structure and design. It should be emphasized, however, that the present invention is not limited to particular systems and methods for providing investment opportunities as shown and described. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting.

The use of terms “including,” “comprising,” or “having” and variations thereof herein is meant to encompass the items listed thereafter and equivalents thereof as well as additional items.

Furthermore, the terms, “a” and “an” herein do not denote a limitation of quantity, but rather denote the presence of at least one of the referenced item.

The present invention provides systems and methods for providing investment opportunities. The term ‘investment opportunities’ as mentioned herein refers to possibilities of investing of money or capital in order to gain profitable returns, as interest, income, or appreciation in value. Suitable examples of such investment opportunities may include, but are not limited to, expending money with the expectation of achieving a profit or material result by putting it into financial schemes, stocks, shares, debentures, products, property, brands and the like. The term ‘investment opportunities’ as mentioned herein may also refer to the possibility of purchasing a financial product or other item of value with the expectation of favorable future returns. In accordance with one embodiment, the investment opportunities may include stock symbols or stock exchange information that will enable the user to invest or purchase shares in a business. The term ‘investment opportunities’ as mentioned herein includes the term ‘investment options’.

The term ‘communication device’ as mentioned herein refers to any device that can be used to convey any kind of message from one person to another, or could be used for the processing of data. Suitable examples of such communication devices may include, but are not limited to, cellular phones, computers, laptops, PDA (Professional Digital Assistants), smart phones, tablet computers, and the like. Therefore, term ‘communication device’ as mentioned herein may also refer to any device that assists in the transmission of data.

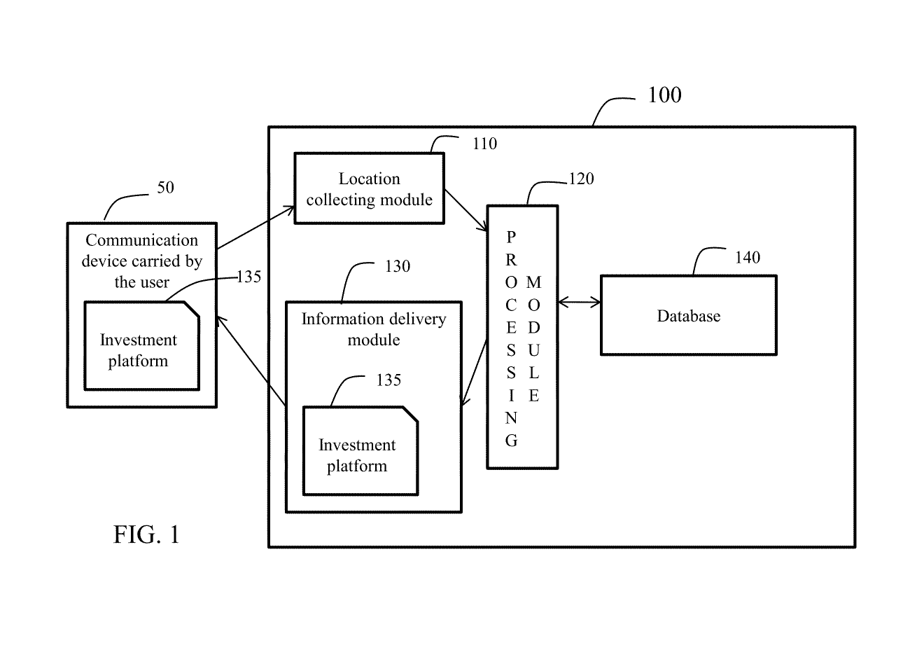

The term ‘communication network’ as mentioned herein refers to a network which is a collection of computers and other hardware components interconnected by communication channels that allow for the sharing of resources and information. Suitable examples of such communication network may include, wired and wireless networks, examples of which include but are not limited to, local networks, LANs (Local Area Networks), MANs (Municipal Area Networks) and widely distributed networks, WANs (Wide Area Networks) such as the Internet, a combination of these, or such other network arrangements as would occur to those skilled in the art. The term ‘processor’ as mentioned herein below refers to any device capable of executing a sequence of instructions. The term ‘location’ as mentioned herein refers to a particular place or position. Suitable examples of a location may include, but are not limited to, a place of settlement, activity or residence. The term ‘location’ as mentioned herein may also refer to location information defined by a Global Positioning System (GPS) and location information sent via a Global System for Mobile (GSM) Cellular Network. The term ‘graphical image’ as mentioned herein refers to the representation and manipulation of an image data by a device with help from specialized software and hardware. Suitable examples of a graphical image may include, but are not limited to, an image of a product, landmark or person. Various embodiments of the systems and methods for providing investment opportunities will now be explained in conjunction with FIGS. 1-12.

FIG. 1 depicts a block diagram of a system 100 that provides investment opportunities corresponding to a location, according to a first embodiment of the present invention. As shown in FIG. 1, the system 100 includes a location collecting module 110 in communication with a communication device 50 carried by the user, a processing module 120 in communication with the location collecting module 110, an information delivery module 130 in communication with the processing module 120, an investment platform 135 integrated with the information delivery module 130, and at least one database 140 (only one database is shown) in communication with the processing module 120. These components of the system 100, and their correlation with the system 100, will now be explained one by one.

As mentioned hereinabove, the system 100 includes the location collecting module 110. The location collecting module 110 is the front end of the system 100 which is in direct communication with the user. The location collecting module 110 is functionally adapted to collect location information from the communication device 50 carried by the user.

More specifically, the location collecting module 110 is configured to collect details of the location of the user by automatically identifying Global Positioning System (GPS) coordinates of the communication device 50 carried by the user. It will be apparent to a person skilled in the art that such collection may be automatic in nature, that is, the communication device 50 may be in continuous communication with the location collecting module 110, and the communication device 50 may provide information about the location to the location collecting module 110 after a predetermined interval of time. In accordance with one embodiment, the location collecting module 110 is configured to the collect the latitude and longitude coordinates from the GPS system of the communication device 50. In accordance with another embodiment, the location collecting module 110 is functionally adapted to collect the location information automatically by known methods in the art. For example, the location collecting module 110 is functionally adapted to collect four key pieces of data that includes: the Cell Tower ID, the Location Area Code (LAC), the Mobile Network Code (MNC), and the Mobile Country Code (MCC), for evaluating the GPS location. Furthermore, the location collecting module 110 may translate this cell tower data into an HTTP request and may determine the latitude and longitude coordinates.

In accordance with one embodiment, the location collecting module 110 is configured to collect location information from the user by receiving the location details inputted by the user into the communication device 50. The user inputs at least one type of information comprising the GPS coordinate information, city information, town name information, or the village name information in the communication device 50 carried by the user. This inputted location information is then received by the location collecting module 110.

For facilitating the inputting of the information, an input interface may be provided to the user. This input interface may be similar to a webpage, or an application interface capable of receiving the location information from the user. It will be apparent to a person skilled in the art that such implementation on the application interface may be a non-webpage (that is, a native iPhone/Android/Windows Phone application). Furthermore, in accordance with one embodiment, the location collecting module 110 is similar to a web page, accessible either through a standard web browser or through a mobile web service, where the user may interact virtually with the system 100 through the webpage. However, such an example of the interface should not be construed as a limitation to the present invention. The webpage may be in any format, such as, for example, HTML or XHTML format, or any other known format. It will be apparent to a person skilled in the art that the location collecting module 110 may have one or more pieces of hardware driven by a set of instructions to facilitate the aforesaid functionalities.

The system 100 further includes the processing module 120. The processing module 120 is configured to identify the location of the user based upon the collected location information and to retrieve an investment opportunity corresponding to the identified location.

More specifically, the processing module 120 is functionally adapted to identify a list of companies located proximal to the identified location and to provide the list of companies to the information delivery module 130 which then, in turn, provides the information to the user. In accordance with one embodiment, the processing module 120 may identify all the companies whose address is within a predetermined radius of the identified location, and provides this information to the information delivery module 130.

Furthermore, in accordance with one embodiment, the processing module 120 is configured to identify “business information” corresponding to the identified list of companies and to provide the business information to the information delivery module 130. In accordance with one embodiment, the business information includes information such as information about the sector in which each of the company belongs, information about the industry, social media information related to the company, and information about competing companies corresponding to the each of the identified list of companies. However, such examples of business information should not be construed as limitations to the present invention.

In this manner, the system 100 identifies a list of companies that are disposed close to the location information identified or inputted by the user, and then provides detailed information about each one of the identified companies. As mentioned above, the detailed information may include the entire business history about the company, financial information, (for example, a stock chart, stock symbol, stock exchange information) description, twitter, facebook, YouTube pages, (that is, online presence information) and the like for the company where available. The online presence information may allow the user to communicate with the company. For example, the user may write upon the company's facebook wall, send the company a twitter message, comment on their YouTube channel, and the like. This is an advantageous feature of the present invention.

In accordance with one embodiment, the processing module 120 is configured to identify a list of companies headquartered proximal to the location of the user and to provide the list of companies to the information delivery module 130. In other words, the system 100 is able to identify a list of companies that have headquarters or locations close to or within a predetermined radius of the location information identified or inputted by the user, and then provides detailed information about the identified companies. The detailed information is similar to the information as mentioned above. In this manner, the user obtains information about an additional set of companies that are headquartered or located near the identified location. This increases the scope of uncovering relevant investment opportunities for the user, and the user may therefore be able to uncover investment related opportunities.

Specifically as shown in FIG. 1, the system 100 includes a information delivery module 130 which is functionally adapted to receive the investment opportunity information from the processing module 120 and to provide the investment related information to the communication device 50 carried by the user. In accordance with one embodiment, the information delivery module 130 is similar to a web page, wherein the user may interact virtually with the system 100 through the webpage, and provides investment related information to the communication device 50 carried by the user. The information delivery module 130 may be similar to a webpage, or an application interface capable of receiving the information from the processing module 120, and can forward it to the user. Furthermore, in accordance with one embodiment, the information delivery module 130 is similar to a web page wherein the user may interact virtually with the system 100 through the webpage. However, such an example of the information delivery module 130 should not be construed as a limitation to the present invention. The webpage may be in any format, such as HTML or XHTML format, or any known format in the art. It will be apparent to a person skilled in the art that the information delivery module 130 may have one or more pieces of hardware driven by a set of instructions to facilitate the aforesaid functionalities.

Furthermore, in accordance with one embodiment, the system 100 also includes an investment platform 135. The investment platform 135 is configured to enable the user to use the identified investment related information for transacting in stocks corresponding to the investment related information. The investment platform 135 is similar to known investment platforms in the art, wherein the same can be integrated into the system 100, especially within the communication device 50 carried by the user, so as to allow the user to invest in interesting stocks. In accordance with one embodiment, this investment platform 135 may be operated by a third party. Examples of such an investment platform 135 include Ameritrade™, OptionsXpress™, Tradeking™, Charles SCHWAB™, and the like. However, such examples should not be construed as a limitation of the present invention. Accordingly, the investment platform 135 may be developed having functionalities similar to the platforms mentioned above.

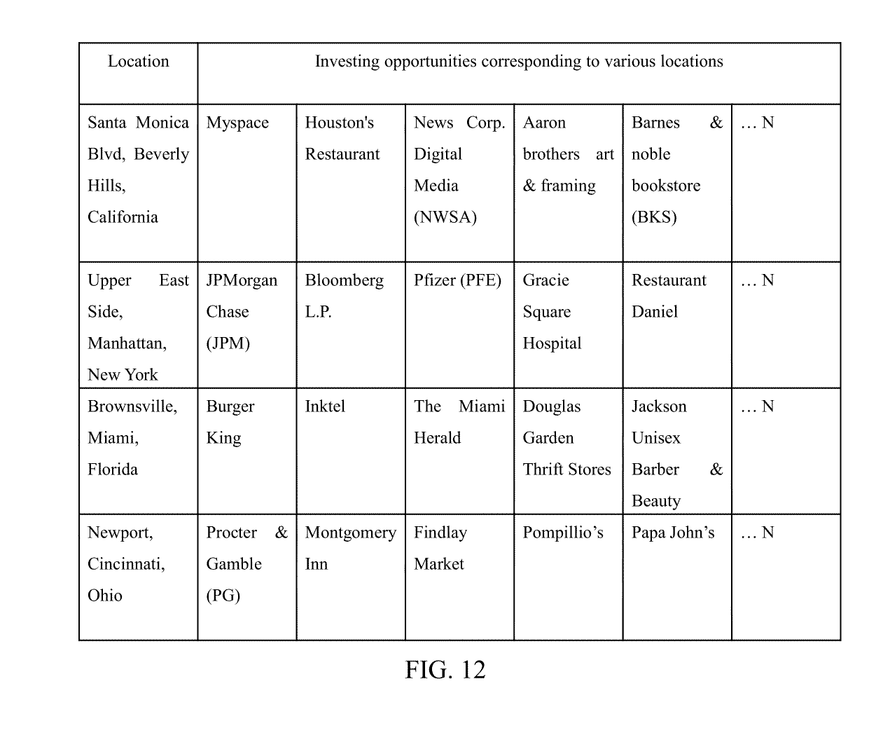

The system 100 further includes at least one database 140 (only one database is shown). More specifically, the database 140 is one having investment opportunities corresponding to a plurality of locations pre-stored therein. It should be noticed that though the database 140 is shown as part of the system 100, in accordance with one embodiment, the database 140 may be located outside the system 100. The database 140 may, in such case, be hosted by different service providers, and may be coupled to the system 100. For example, the database 140 may store a list of companies corresponding to different locations, as shown in FIG. 12, and corresponding details of the list of companies. Similarly, the database 140 may store a list of companies headquartered or located near different locations. In a similar manner, the database 140 may store business information about each of the companies.

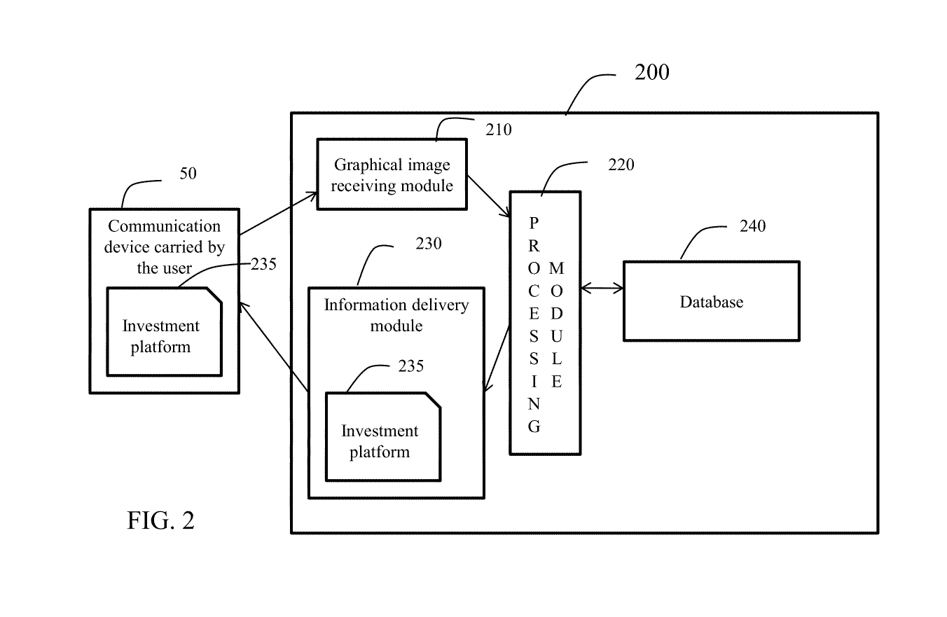

In accordance with another aspect, the present invention provides investment opportunities corresponding to graphical images uploaded by the user. FIG. 2 depicts a block diagram of a system 200 that provides investing opportunities corresponding to a graphical image, according to one embodiment of the present invention. As shown in FIG. 2, the system 200 includes a graphical image receiving module 210, a processing module 220 in communication with the graphical image receiving module 210, an information delivery module 230 in communication with the processing module 220, an investment platform 235 integrated with the information delivery module 230, and at least one database 240 (only one database is shown) in communication with the processing module 220. These components of the system 200 will now be explained one by one.

As mentioned above, the system 200 includes the graphical image receiving module 210. The graphical image receiving module 210 is the front end of the system 200 which is in direct communication with the user. The graphical image receiving module 210 is configured to receive a graphical image from the communication device 50 carried by the user. In other words, this allows the user to capture images of the environment surrounding where he/she may be located and process that image to identify investment opportunities therefrom. In this manner, the user may be able to uncover the brand or companies or stock symbols, of which he/she may be unaware of, and understand the investment opportunities associated from the surroundings. In one case, a user may be visiting a shopping mall, and sees a store whose name and history he/she is unaware of or unfamiliar with. The user may click an image of the store and provide this to the system 200 which will then communicate business information about the store, the company running the store, its history, competitors of the store, information about the sector, stock symbol, stock exchange information, and other like information.

More specifically, the graphical image receiving module 210 is functionally adapted to receive a graphical image from the communication device 50 carried by the user. Furthermore, in accordance with one embodiment, the graphical image receiving module 210 is similar to a web page, accessible either through a standard web browser or through a mobile web service, whereby the user may interact virtually with the system 200 through the webpage. In another embodiment, the graphical image receiving module 210 is similar to a mobile application integrated on the communication device 50 carried by the user. However, such an example of the graphical image receiving module 210 as the front end should not be construed as a limitation to the present invention. The webpage may be in any format, such as HTML or XHTML format, or any known format in the art. It will be apparent to a person skilled in the art that the graphical image receiving module 210 may have one or more pieces of hardware driven by set of instructions to facilitate the aforenoted functionalities.

The system 200 further includes a processing module 220. The processing module 220 is configured to identify the graphical image received from the user, and to retrieve an investment option corresponding to the identified graphical image. More specifically, the processing module 220 is configured to process the graphical image to identify investment parameters associated with the image. In accordance with one embodiment, the investment parameters are at least one of a company or a brand associated with the image. This may further include information about the sector in which each of the company belongs, business information about the industry, social media information related to the company, and information about competing companies corresponding to the each of the identified companies. However, such examples of investment parameters should not be construed as limitations to the present invention.

Furthermore, the processing module 220 is configured to identify investment options corresponding to predetermined parameters. Still further, the processing module 220 is configured to provide the investment options to the communication device 50 carried by the user. Yet further, the processing module 220 is configured to identify business information corresponding to the identified parameters, and to provide such business information to the communication device 50 carried by the user. In accordance with another embodiment, the business information comprises at least one of sector information, industry information, or competing company information corresponding to the list of companies.

For enabling the above mentioned functionalities or operations, the processing module 220 may use any software known in the art for processing the image. The software may be capable of analyzing the uploaded graphical image and identifying various pointers in the image. In accordance with one embodiment, the software may be capable of identifying investment related pointers corresponding to the graphical image. For example, the software may determine the company name, if mentioned anywhere on the graphical image, or a depiction which associates the graphical image to a brand.

Specifically as shown in FIG. 2, the system 200 also includes an information delivery module 230 which is functionally adapted to receive the investment options from the processing module 220 and to provide the investment options to the communication device 50 carried by the user. In accordance with one embodiment, the information delivery module 230 is similar to a web page, wherein the user may interact virtually with the system 200 through the webpage, and provides the investment options to the communication device 50 carried by the user. In accordance with another embodiment, the information delivery module 230 is similar to a mobile application integrated within the communication device 50 carried by the user.

In other words, the information delivery module 230 provides an interface where it provides the investment options to the communication device 50 carried by the user.

Furthermore, the system 200 may also include an investment platform 235. The investment platform is configured to enable the user to use the identified investment options for transacting in the stocks corresponding to the investment options. The investment platform 235 is similar to the investment platform 135 as described above.

Still further, the system 200 includes at least one database 240 (only one database is shown). More specifically, the database 240 has investment options corresponding to a plurality of graphical images pre-stored therein. The database 240 is similar to the database 140 as described above.

The functional relationship of the various components as described above will now be explained in the foregoing description.

In use, the system 100 may be used by the user to explore various investment opportunities, that is, the system 100 acts as a tool by means of which the user is able to identify various investment opportunities in their proximity and use the investment opportunities for investment related needs.

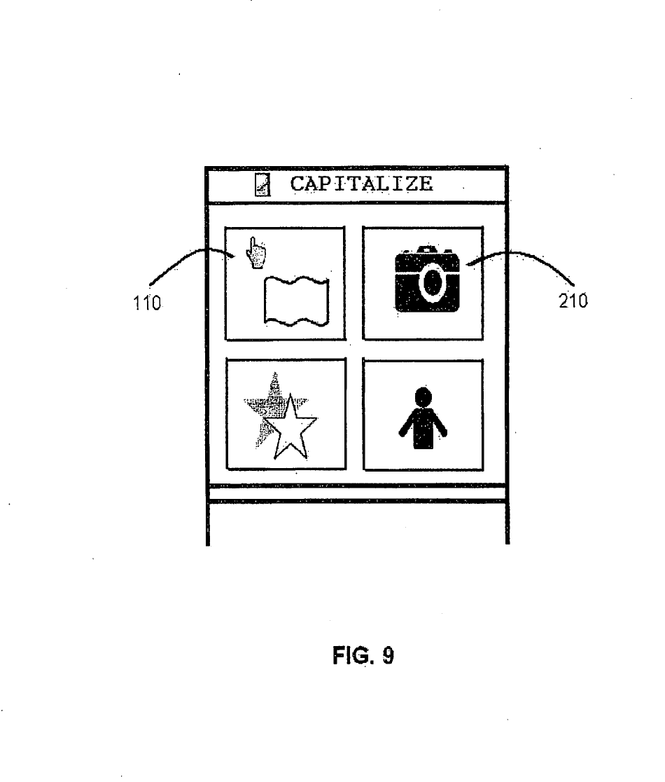

In the case where the user intends to explore investment opportunities located nearby, the user either provides the location information, or the location is gathered by the location collecting module 110 of the user. As mentioned above, the location collecting module 110 is in direct communication with the user. In accordance with one embodiment, the location collecting module 110 is shown in FIG. 9. The location collecting module 110 collects the location information by identifying Global Positioning System (GPS) coordinates of the communication device 50 carried by the user. In accordance with one embodiment, the location collecting module 110 collects the location information from the user by receiving the location details inputted by the user in the communication device 50 wherein the user inputs at least one of GPS coordinate information, city information, town name information, or village name information, into the communication device 50 carried by the user. The location collecting module 110 then sends the collected location information to the processing module 120.

The processing module 120 identifies the location of the user based upon the collected location information and retrieves an investment opportunity, corresponding to the identified location, from the database 140 which has pre-stored therein investment opportunities corresponding to a plurality of locations also pre-stored therein, as shown in FIG. 12, which is a table showing locations and corresponding investment opportunities in the database 140 in accordance with one embodiment of the present invention. More specifically, the processing module 120 identifies a list of companies or brands, located proximal to the identified location, from the database 140 and provides the list of companies to the information delivery module 130. In accordance with one embodiment, the processing module 120 identifies a list of companies headquartered or located proximal to the location of the user from the database 140 and provides the list of companies to the information delivery module 130.

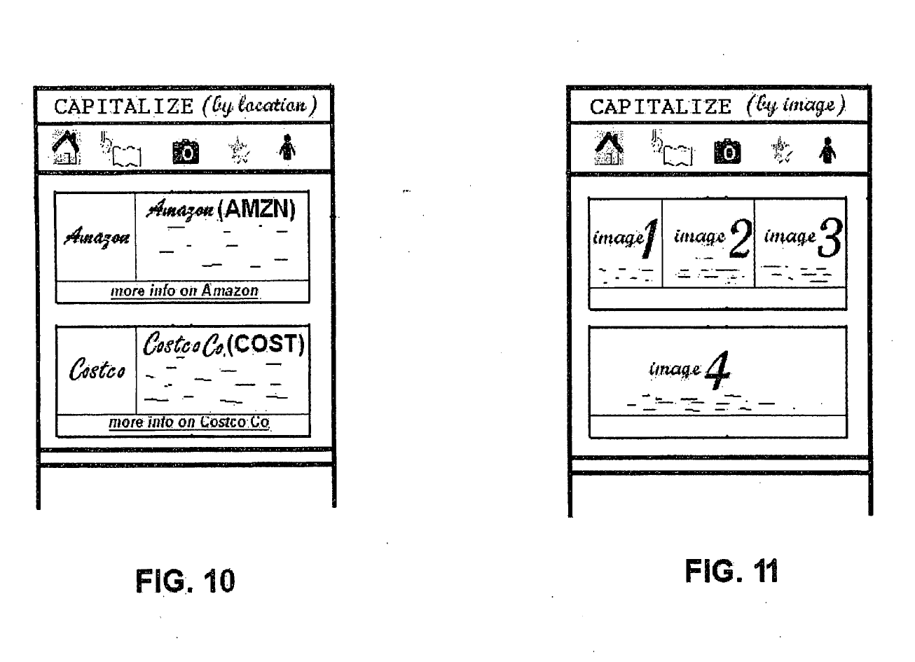

Furthermore, the processing module 120 identifies business information corresponding to the identified list of companies from the database 140 and also provides the identified business information to the information delivery module 130. The business information can be financial information (for example, a stock chart, stock symbol, stock exchange information), description, twitter, facebook, YouTube pages (that is, online presence info) for the company where available, as shown in FIG. 10. The online presence information may allow the user to communicate with the company. For example, the user may write upon the company's facebook wall, send them a twitter message, comment on their YouTube channel, or the like.

Still further, the information delivery module 130 receives the investment opportunity from the processing module 120 and provides the investment related information to the communication device 50 carried by the user as shown in FIG. 10. In accordance with one embodiment, the information delivery module 130 provides an interface wherein it provides the investment related information, and delivers it to the communication device 50 carried by the user.

The investment platform 135 which is integrated within information delivery module 130 enables the user to use the identified investment related information for transacting in the stocks corresponding to the investment related information. In this manner, the system 100 provides a mechanism by which a user can explore various investment opportunities and use the investment opportunity for their investment related needs as shown in FIG. 12, wherein the account of the user is shown in the system 100 displaying user's activities.

In case the user intends to explore investment opportunities from environments or other nearby locations, the system 200 assists him/her in doing so. For example, the user may intend to identify investment opportunities from what he/she sees around him/her. In such case, the user provides a graphical image, such as a photograph of what he sees, to the graphical image receiving module 210 of the system 200. As mentioned above, the graphical image receiving module 210 is in direct communication with the user. The graphical image receiving module 210 as shown in FIG. 9 receives the graphical image from the communication device 50 carried by the user. The graphical image receiving module 210 then sends the received graphical image to the processing module 220.

The processing module 220 processes the received graphical image so as to identify investment parameters associated with the image from the database 240. Furthermore, the processing module 220 then identifies investment options corresponding to the parameters from the database 240. Still further, the processing module 220 sends the investment options to the information delivery module 230 which further provides it to the communication device 50 carried by the user. Yet further, the processing module 220 identifies business information corresponding to the identified parameters from the database 240, and provides the identified business information to the information delivery module 230 which, in turn, further provides it to the communication device 50 carried by the user as shown in FIG. 11.

In accordance with one embodiment, the information delivery module 230 provides an interface wherein it provides business information and delivers it to the communication device 50 carried by the user.

The investment platform 235 which is integrated within the information delivery module 230 enables the user to use the identified business information for transacting in the stocks corresponding to the business information.

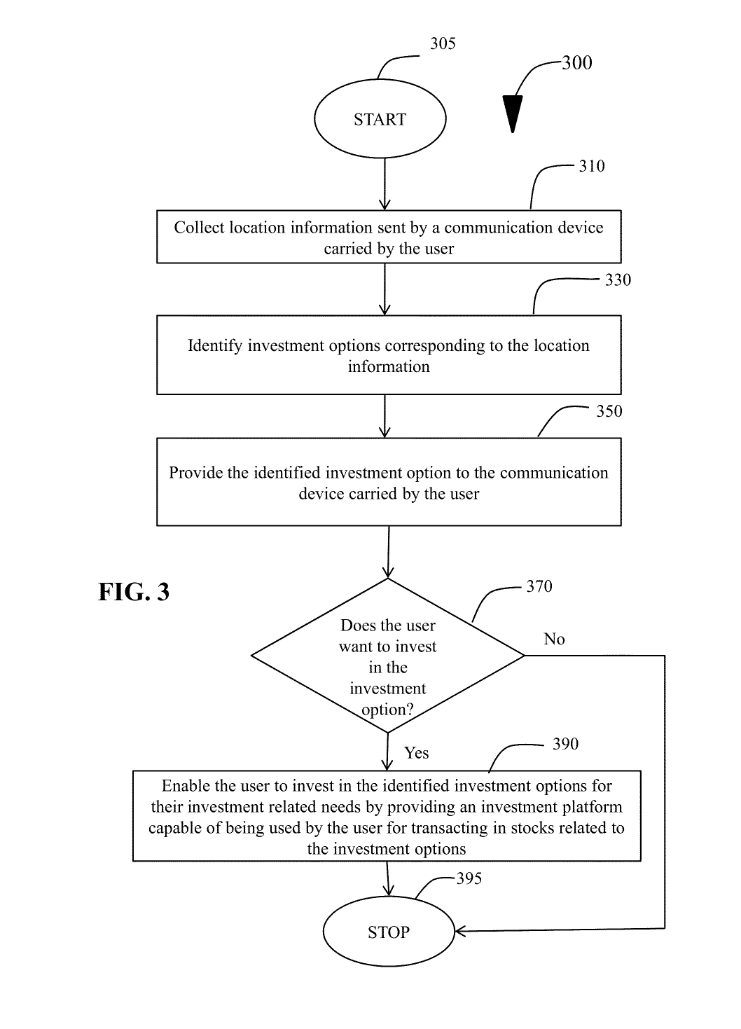

The methods of the present invention will now be explained with respect to FIGS. 3-8 and with respect to the foregoing description.

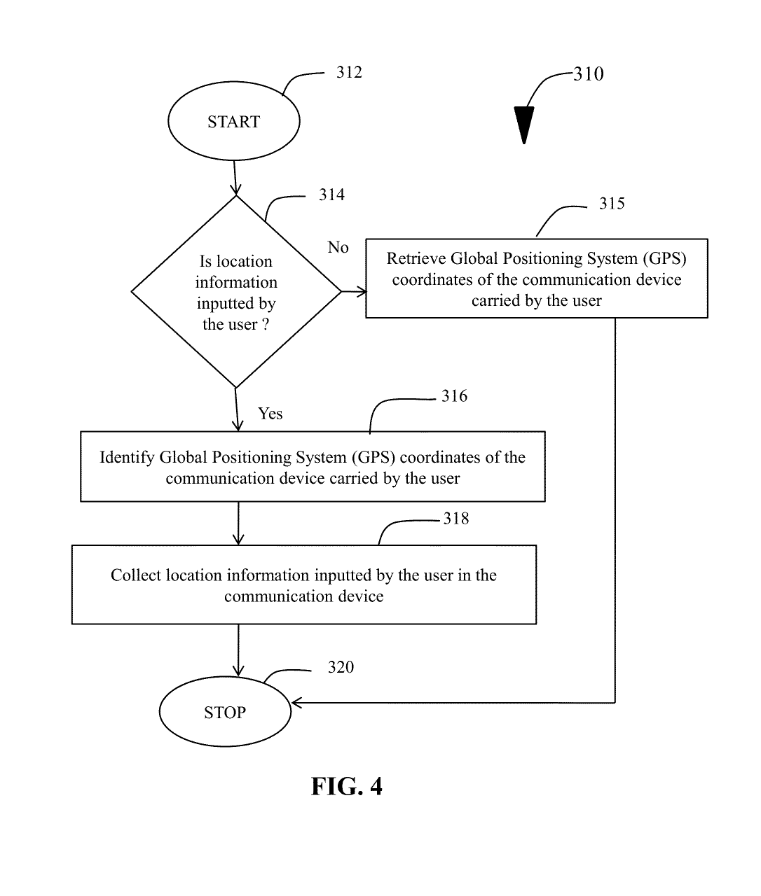

In FIG. 3, there is shown a flow diagram of a method for identifying and providing investment options corresponding to location information. The method 300 initiates at block 305. Thereafter, the method 300 flows to the block 310. At block 310, the method 300 includes collecting location information by the location collecting module 110 of the system 100 which is sent by a communication device 50 carried by the user. How the method 300 collects the location information will now be explained with reference to FIG. 4.

In FIG. 4, there is shown a method 310 for collecting location information sent by a communication device 50 carried by the user. The method 310 starts at block 312. Thereafter, the method 310 flows to block 314, which is a decision box. At block 314, the method 310 includes determining whether the user has inputted the location information at location collecting module 110 of the system 100? If answer to the question is “NO”, the method 310 then identifies Global Positioning System (GPS) coordinates of the communication device 50 carried by the user at block 316. The method 310 thereafter stops at the block 320.

If answer to the question at block 314 is “YES”, the method 310 flows to the block 316 as shown in FIG. 4. The method 310 in such cases uses the inputted location information. In accordance with one embodiment, the location collecting module 110 collects the location information from the user by receiving the location details inputted by the user into the communication device 50 wherein the user inputs at least one of GPS coordinate information, city information, town name information, or village name information into the communication device 50 carried thereby. Thereafter, the method 310 stops at the block 320.

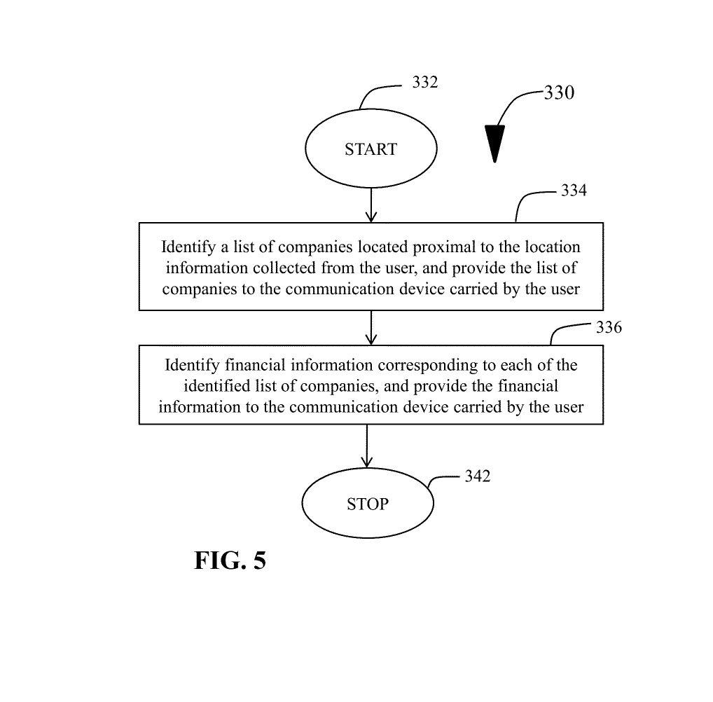

Subsequently, the method 300 flows to the block 330 as shown in FIG. 3. At block 330, the method 300 includes identifying investment options corresponding to the location information by the processing module 120 from the database 140. How the method 300 identifies investment options corresponding to the location information will now be explained with reference to FIG. 5.

In FIG. 5 there is shown a method 330 for identifying investment options corresponding to the location information. The method 330 starts at block 332. Thereafter, the method 330 flows to the block 334 which includes identifying a list of companies located proximal to the location information collected from the user by the processing module 120 from the database 140, and providing the list of companies, to the communication device 50 carried by the user, by means of the information delivery module 130. The method 330 thereafter flows to the block 336, which includes identifying business information corresponding to each of the identified list of companies by the processing module 120 from the database 140, and providing the business information to the communication device 50 carried by the user by means of the information delivery module 130. In accordance with one embodiment, identifying business information comprises identifying at least one of sector information, industry information, or competing companies information corresponding to the list of companies. Thereafter, the method stops at the block 342.

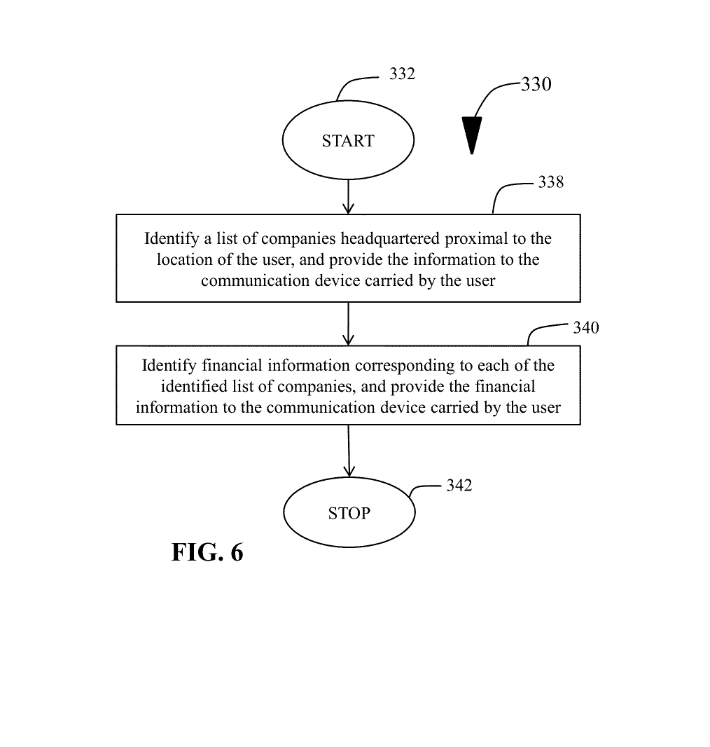

In one embodiment, as shown in FIG. 6 there is shown a method 330 for identifying investment options corresponding to the location information. The method 330 starts at block 332. Thereafter, the method 330 flows to the block 338 which includes identifying a list of companies headquartered or located proximal to the location of the user, by the processing module 120 from the database 140, and providing the information to the communication device 50, carried by the user, by means of the information delivery module 130. The method 330 thereafter flows to the block 340 which includes identifying business information corresponding to each one of the identified list of companies by the processing module 120 from the database 140, and providing the business information to the communication device 50, carried by the user, by the information delivery module 130. Thereafter, the method stops at the block 342.

Thereafter, the method 300 flows to the block 350. At block 350, the method 350 includes providing the identified investment option to the communication device 50, carried by the user, by means of the information delivery module 130. The method 300 thereafter flows to the block 370 which is a decision box. At 370, the method 300 includes determining whether the user wants to invest in the investment option? If answer to the question is “NO”, the method 300 thereafter stops at 395.

If answer to the question at block 370 is “YES”, the method 300 flows to the block 390. At block 390, the method includes enabling the user to invest in the identified investment options for the investment related needs by providing an investment platform which is the investment platform 135 which is capable of being used by the user for transacting in stocks related to the investment options. The method 300 thereafter stops at the block 395.

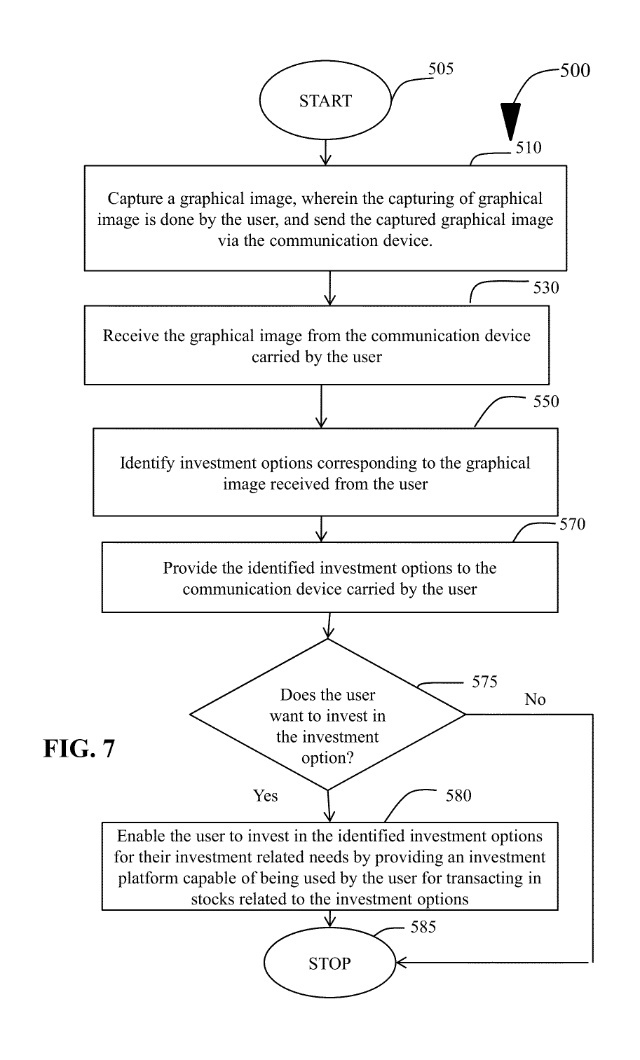

In FIG. 7, there is shown a method 500 of system 200 that provides investing opportunities corresponding to a graphical image according to an embodiment of the present disclosure. The method 500 initiates at the block 505. Thereafter, the method 500 flows to the block 510 which includes capturing a graphical image, wherein the capturing of graphical image is done by the user, and sending of the captured graphical image via the communication device 50 to the processing module 220 through means of the graphical image receiving module 210.

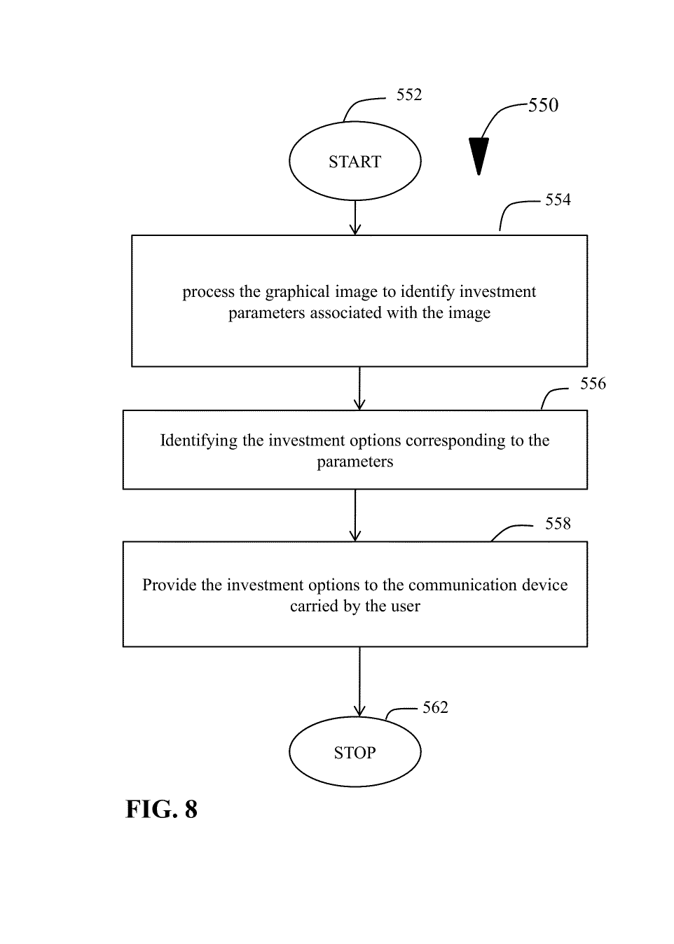

The method 500 thereafter flows to the block 530 which includes receiving the graphical image by the processing module 220 from the communication device 50 carried by the user. The transmitted graphical image is received by the computer-implemented system. Thereafter, the method 500 flows to the block 550 which includes identifying investment options corresponding to the graphical image received from the user. How the method 500 identifies investment options corresponding to the graphical image will now be explained with reference to FIG. 8.

In FIG. 8 there is shown a method 550 for identifying investment options corresponding to the graphical image. The method 550 starts at block 552. Thereafter, the method 550 flows to the block 554 which includes processing the graphical image so as to identify investment parameters associated with the image by the processing module 220. Investment parameters are at least one of a company or a brand associated with the image. The method 550 thereafter flows to the block 556 which includes identifying the investment options corresponding to the parameters by the processing module 220. Thereafter, the method 550 flows to the block 558 which includes providing the investment options to the communication device 50, carried by the user, by means of the information delivery module 230. The method 550 thereafter stops at the block 562.

Thereafter, the method 500 flows to the block 570 as shown in FIG. 7. At block 570, the method 500 includes providing the identified investment options to the communication device 50 carried by the user. The method 500 flows to the block 575, which is a decision box. At 575, the method 500 includes determining whether the user wants to invest in the investment option? If answer to the question is “NO”, the method 500 stops at the block 585.

If answer to the question is “YES”, the method 500 flows to the block 580 which includes enabling the user to invest in the identified investment options for their investment related needs by providing an investment platform that is the investment platform 235 of the system 200 which is capable of being used by the user for transacting in stocks related to the investment options. The method thereafter stops at the block 585.

As described above, the present invention provides systems and methods for providing investing opportunities. The systems and methods provide investment opportunities based upon a location of a user's choice and/or of a graphical image as provided by the user. The business information which is provided is of the kind which can be used for investment opportunities. The identified business information is provided in an effective and efficient manner. Furthermore, when the user is interested to know about companies or related sectors, or is interested to invest in companies or in related sectors, the present invention systems and methods determine a way to quickly provide what options are available in the given area to meet the particular needs. Still further, the present invention systems and methods provide investing and other related business information to the user corresponding to a particular location. Yet further, investing and other related business information is provided to the user corresponding to a graphical image provided by the user. The present invention systems and methods allow the user to use the identified investing and other related business information for his investment purposes.

In accordance with another aspect, the present invention provides a machine-readable medium including machine-readable instructions which causes a processor to perform some or all of the operations described above. In some embodiments, the operations may be performed by specific hardware components that contain hardwired logic. Those operations may alternatively be performed by any combination of programmed computer components and custom hardware components.

A machine-readable medium may include any mechanism for storing or transmitting information in a form readable by a machine, (for example, a computer) including but not limited to Compact Disc Read-Only Memory (CD-ROMs), Read-Only Memory (ROMs), Random Access Memory (RAMs), Erasable Programmable Read-Only Memory (EPROMs), and transmissions over the internet.

The foregoing descriptions of the specific embodiments of the present invention have been presented for purposes of illustration and description. They are not intended to be exhaustive or to limit the invention to the precise forms disclosed, and obviously many modifications and variations are possible in light of the above teaching. The exemplary embodiments were chosen and described in order to best explain the principles of the invention and its practical applications and to thereby enable others skilled in the art to best utilize the invention and various embodiments with various modifications as are suited to the particular use contemplated.

1. A method for providing investment opportunities to a communication device carried by a user, wherein the method is implemented by a computer-implemented system in communication with the communication device via a communication network, the method comprising the steps of:
collecting location information sent by the communication device;
identifying investment options corresponding to the collected location information; and
providing the identified investment options to the communication device carried by the user whereby the user is enabled to invest in at least one of the identified investment options for investment related needs.

2. The method of claim 1, wherein the enabling of the user to invest in at least one of the identified investment options further comprises the step of:
providing an investment platform capable of being used by the user for transacting in stocks related to the investment options.

3. The method of claim 1, wherein the collecting location information further comprises the step of:
identifying Global Positioning System (GPS) coordinates of the communication device carried by the user.

4. The method of claim 1, wherein the collecting location information further comprises the step of:
receiving location details manually inputted by the user in the communication device.

5. The method of claim 4, wherein the collecting location information further comprises the step of:
the user inputting at least one of GPS coordinate information, city information, town name information, and village name information into the communication device carried thereby.

6. The method of claim 1, wherein the identifying investment options further comprises the steps of:
identifying a list of companies located proximal to the location information collected from the user; and
providing the list of companies to the communication device carried by the user.

7. The method of claim 6, wherein the identifying investment options further comprises the steps of:
identifying business information corresponding to each one of the identified list of companies; and
providing the business information to the communication device carried by the user.

8. The method of claim 7, wherein the identifying business information further comprises the step of:
identifying at least one of sector information, industry information, competing companies information, and social media information, corresponding to the identified list of companies.

9. The method of claim 1, wherein the identifying investment options further comprises the steps of:
identifying a list of companies located proximal to the location of the user; and
providing the list of companies to the communication device carried by the user.

10-16. (canceled)

17. A system for providing investment opportunities to a communication device carried by a user, the system comprising:
a location collecting module structured to collect location information from said communication device carried by the user;
a processing module in communication with said location collecting module, said processing module configured to identify the location of the user based upon the collected location information, and to retrieve an investment opportunity corresponding to the identified location, wherein the investment opportunity is retrieved from a database having one or more investment opportunities, corresponding to a plurality of locations, pre-stored therein; and
an information delivery module constructed to receive the investment opportunity from said processing module and to provide the investment related information to said communication device carried by the user.

18. The system of claim 17, further comprising:
an investment platform integrated with said information delivery module and said communication device carried by the user, wherein said investment platform is constructed so as to enable the user to use the identified investment related information for transacting in stocks corresponding to the investment related information.

19. The system of claim 17, wherein:
said location collecting module is constructed so as to collect details of the location of the user by identifying Global Positioning System (GPS) coordinates of the communication device carried by the user.

20. The system of claim 17, wherein:
said location collecting module is configured to collect location information from the user by receiving the location details inputted by the user into the communication device.

21. The system of claim 20, wherein:
the user inputs at least one of GPS coordinate information, city information, town name information, and village name information into the communication device.

22. The system of claim 17, wherein:
said processing module is constructed so as to identify a list of companies located proximal to the identified location, wherein the list of companies are identified from said database, and to provide the list of companies to the information delivery module for transmission to the communication device carried by the user.

23. The system of claim 22, wherein:
said processing module is further constructed so as to identify business information corresponding to the identified list of companies, and to provide said business information to said information delivery module for transmission to said communication device carried by the user.

24. The system of claim 23, wherein:
said business information comprises at least one of sector information, industry information, competing companies information, and social media information corresponding to said identified list of companies.

25. The system of claim 17, wherein:
said processing module is constructed so as to identify a list of companies disposed proximal to the location of the user, and to provide said list of companies to said information delivery module for transmission to said communication device carried by the user.

26. The system of claim 25, wherein:
said processing module is further constructed so as to identify business information corresponding to said identified list of companies, and to provide said business information to said information delivery module for transmission to said communication device carried by the user.

27-32. (canceled)

33. A computer program product for use with a computer, said computer program product comprising a computer useable medium having a computer readable program code stored thereon for providing investment opportunities to a communication device carried by a user, said computer program product capable of performing the steps of:
collecting location information from said communication device carried by the user;
identifying investment options corresponding to said collected location information; and
providing said identified investment options to said communication device carried by the user, whereby the user is enabled to invest in at least one of said identified investment options for investment related needs.

34. The computer program product of claim 33, wherein:
said enabling the user to invest in said identified investment options comprises the additional step of providing an investment platform capable of being used by the user for transacting in stocks related to said investment options.

35. The computer program product of claim 33, wherein:
said collecting location information comprises identifying Global Positioning System (GPS) coordinates of said communication device carried by the user.

36. The computer program product of claim 33, wherein:
said collecting location information comprises receiving location details manually inputted by the user into said communication device.

37. The computer program product of claim 33, wherein:
said identifying investment options comprises identifying business information; and providing said business information to said communication device carried by the user.

38. The computer program product of claim 33, wherein:
said identifying investment options further comprises identifying a list of companies located proximal to the location of the user, and providing said list of companies information to said communication device carried by the user.

39. A method for providing investment opportunities to a communication device carried by a user, wherein the method is implemented by a computer-implemented system in communication with the communication device via a communication network, the method comprising the steps of:
collecting information, based upon a predetermined factor, sent by the communication device;
identifying investment options corresponding to the collected information; and
providing identified investment options to the communication device carried by the user whereby the user is enabled to invest in at least one identified investment option for investment related needs.

40. The method as set forth in claim 39, wherein:
said predetermined factor is location.

41. A system for providing investment opportunities to a communication device carried by a user, the system comprising:
a collecting module structured to collect information from said communication device carried by the user based upon a predetermined factor;
a processing module in communication with said collecting module, said processing module configured to retrieve an investment opportunity corresponding to said predetermined factor, wherein the investment opportunity is retrieved from a database having one or more investment opportunities, corresponding to said predetermined factor, pre-stored therein; and
an information delivery module constructed to receive the investment opportunity from said processing module and to provide the investment related information to said communication device carried by the user.

42. The system as set forth in claim 41, wherein:
said predetermined factor comprises location.
